(19) United States
(12) Patent Application Publication
(10) Pub. No.: US 2026/0088922 A1
(43) Pub. Date: Mar. 26, 2026

(54) METHODS, SYSTEMS, AND DEVICES FOR VEHICLE-BASED MEDIA SYSTEMS

(71) Applicant: Gracenote, Inc., New York, NY (US)

(72) Inventors: Damon Fasching, San Francisco, CA (US); Ashley Michelle Adams, Walnut Creek, CA (US); Gregory Carl Peters, Boulder Creek, CA (US); Kathyrene Villariba, Danville, CA (US); John Michael Colton, Portland, ME (US); Seth Garrison Schulte, San Francisco, CA (US); Maryann Katherine Faricy, San Francisco, CA (US); Lisa Marie Tyler, San Anselmo, CA (US); Mary Beth Russell, Piedmont, CA (US)

(21) Appl. No.: 18/895,101

(22) Filed: Sep. 24, 2024

(51) Int. Cl. H04H 40/18; H04B 17/318; H04B 17/336; H04L 65/611

(52) U.S. Cl. CPC H04H 40/18; H04B 17/318; H04B 17/336; H04L 65/611

(57) ABSTRACT

In one aspect, an example computer-implemented method includes (a) receiving, from a first media source, first media content, wherein the first media content is associated with a content ID, (b) identifying second media content associated with a second media source, (c) determining that the second media content is associated with the content ID, (d) determining that the received first media content exceeds a predetermined threshold of one or more parameters, and (e) in response to determining that the received first media content exceeds the predetermined threshold of the one or more parameters, outputting, via a vehicle-based media system, from the second media source, the second media content.

### USAGE AND TERMINOLOGY

In this disclosure, unless otherwise specified and/or unless the particular context clearly dictates otherwise, the terms “a” or “an” mean at least one, and the term “the” means the at least one.

### BACKGROUND

Vehicle-based media systems can receive media content to be presented to one or more occupants of a vehicle. For example, a vehicle-based media system can include an antenna configured to receive a radio signal, such as a digital radio signal (e.g., HD radio), a satellite radio signal, and/or a terrestrial radio signal that carries media content. A vehicle-based media system may also receive media content over an Internet signal, such as a mobile data signal (e.g., via a mobile device associated with the vehicle-based media system). The vehicle-based media system can output the media content through one or more speakers located within the vehicle.

### SUMMARY

In one aspect, an example vehicle-based media system is disclosed. The example vehicle-based media system comprises (a) one or more processors, and (b) a non-transitory machine-readable medium, having stored thereon program instructions that, upon execution by the one or more processors, cause the vehicle-based media system to perform a set of operations comprising: (a) receiving, from a first media source, first media content, wherein the first media content is associated with a content ID; (b) identifying second media content associated with a second media source; (c) determining that the second media content is associated with the content ID; (d) determining that the received first media content exceeds a predetermined threshold of one or more parameters; (e) in response to determining that the received first media content exceeds the predetermined threshold of the one or more parameters, outputting, via the vehicle-based media system, from the second media source, the second media content.

In another aspect, an example non-transitory computer-readable medium is disclosed. The example non-transitory computer-readable medium has stored thereon program instructions that, upon execution by a vehicle-based media system, cause the vehicle-based media system to perform a set of operations comprising: (a) receiving, from a first media source, first media content, wherein the first media content is associated with a content ID; (b) identifying second media content associated with a second media source; (c) determining that the second media content is associated with the content ID; (d) determining that the received first media content exceeds a predetermined threshold of one or more parameters; and (e) in response to determining that the received first media content exceeds the predetermined threshold of the one or more parameters, outputting, via the vehicle-based media system, from the second media source, the second media content.

In another aspect, an example computer-implemented method is disclosed. The computer-implemented method includes (a) receiving, from a first media source, first media content, wherein the first media content is associated with a content ID, (b) identifying second media content associated with a second media source, (c) determining that the second media content is associated with the content ID, (d) determining that the received first media content exceeds a predetermined threshold of one or more parameters, and (e) in response to determining that the received first media content exceeds the predetermined threshold of the one or more parameters, outputting, via the vehicle-based media system, from the second media source, the second media content.

### BRIEF DESCRIPTION OF THE DRAWINGS

FIG. 1 is a simplified block diagram of an example computing device.

FIG. 2A is an example graphical user interface (“GUI”) in a first state.

FIG. 2B is the example GUI of FIG. 2A, but in a second state.

FIG. 2C is the example GUI of FIG. 2A, but in a third state.

FIG. 2D is the example GUI of FIG. 2A, but in a fourth state.

FIG. 3A is an example GUI in a first state.

FIG. 3B is the example GUI of FIG. 3A, but in a second state.

FIG. 4 is a flow chart of an example method.

### DETAILED DESCRIPTION

### I. Overview

A vehicle-based media system can receive media content such as audio content over a broadcast (e.g., digital radio, terrestrial radio, and/or satellite radio) and/or Internet-based media stream and present the received media content to one or more occupants of a vehicle. In some examples, the vehicle-based media system may output the media content through one or more speakers of the vehicle and/or transmit the media content to a mobile device connected to the vehicle-based media system. The media content received and played back by the vehicle-based media system can include various types of media content. For instance, the media content can include primary content, such as music, radio programs, or the like, and the media content can include secondary content, such as advertisements, interspersed among the primary content.

Some vehicle-based media systems also include a visual display for displaying visual information to one or more occupants of a vehicle. Such a vehicle-based media system may also be configured to display information related to media content being played back by the media system. For instance, while the media system is playing media content, the media system can cause the visual display to display information identifying the media content, such as a title and/or artist of a song, or identifying a source of the media content, such as a radio station, podcast, media streaming service, or Internet-based media stream, any or all of which may include the media content. In some embodiments, this displayed information may be encoded within and/or pursuant to the radio broadcast and/or Internet stream that is carrying the media content. In a further aspect, the vehicle-based media system can extract this information from the radio broadcast and/or Internet-based media stream (or Internet-based radio stream).

In one example, if the vehicle-based media system receives media content from a terrestrial radio broadcast, such as a song or a radio program, the vehicle-based media system can obtain, from the radio broadcast, and display, via its visual display, information identifying the song or radio program and/or a source of the song or radio program. For instance, for a terrestrial frequency modulation (“FM”) radio broadcast, information can be encoded into the radio signal according to the Radio Broadcast Data System (“RBDS”) communication protocol. As noted above, in the case of an Internet-based media stream, the same or similar information may be included in the stream in the form of metadata. Other examples are possible as well.

In some scenarios, the vehicle-based media system may tune to and/or switch between a terrestrial radio broadcast, a digital radio broadcast, a satellite radio station, a media streaming service, and/or an Internet-based media stream. For example, if a vehicle is traveling outside of the range of a terrestrial broadcast, its media system may switch to an Internet-based stream of the same or similar content to avoid audio quality degradation. Furthermore, this switch may occur in the other direction. For example, if a mobile device or vehicle-based media system is subject to one or more mobile data transmission limitations (e.g., poor service, data limits), then the vehicle-based media system may switch to a terrestrial broadcast of the same content in order to limit the use of mobile data.

However, current vehicle-based media systems and methods of using the same do not allow for such dynamic, effective, or seamless tuning and/or source switching to occur. These limitations lead to several deleterious effects for the users of the vehicle-based media system, including inconsistent and often degraded audio quality, wasted mobile data (including in throttled bandwidth scenarios), and overall poorer listener or user experience related to the media content. Thus, there is a need for current vehicle-based media systems to more effectively and efficiently identify when media content is degrading and when the same or similar media content is available from one or more additional, often more stable and cost-effective, sources. Then, once these sources are identified, improved vehicle-based media systems may intelligently and seamlessly switch and/or tune to the additional source to deliver a higher-quality and/or more cost-effective version of the media content to one or more users of the vehicle-based media system.

Disclosed herein are methods and systems to address this and potentially other issues. In an example method, while a vehicle-based media system is receiving media content associated with a content ID from a first source (e.g., a terrestrial broadcast), the vehicle-based media system may identify second media content associated with a second media source (e.g., an Internet-based media stream) and determines whether the second media content is associated with a same or similar content ID to the first media content. By doing so, in examples, the vehicle-based media system may determine that the second media content may be the same content as the first media content. For example, a terrestrial radio broadcast of a particular baseball game may have the same or similar content ID as an Internet stream of the same baseball game.

Once the second media content is determined to be associated with the content ID, the vehicle-based media system may also determine that the received first media content exceeds a predetermined threshold of one or more parameters. As used herein, the term “exceeds” includes scenarios where media content (including audio content) satisfies and/or passes one or more predetermined thresholds of one or more parameters. Further, in the examples detailed herein, the term “exceeds” includes scenarios where media content (including audio content) passes above one or more predetermined thresholds of one or more parameters, passes below (or drops below) one or more predetermined thresholds of one or more parameters, or both, among other possibilities. In example embodiments, these parameters may include one or more audio characteristic parameters (e.g., signal-to-noise ratio (“SNR”), loudness, gain, timbre), signal characteristics parameters (e.g., signal strength, bitrate, data usage), broadcast equipment parameters (e.g., tower height, power, class; satellite broadcasting frequency, satellite orbital distance or type) and/or geographical parameters (e.g., geolocation data, contour data), among other parameters.

In some examples, these parameters may be used to determine whether the vehicle based media system should switch between and/or tuned to one or more of a terrestrial broadcast, digital radio broadcast, satellite radio station, streaming media service, and/or an Internet-based radio stream. For example, a media system tuned to a terrestrial radio station may switch to an Internet-based stream after determining that the SNR of the radio broadcast exceeds a predetermined threshold, which may indicate poor audio quality. Conversely, a media system using an Internet-based stream may switch to a terrestrial radio station after determining that the bitrate of the stream is too low, thus exceeding a predetermined threshold, and also indicating poor audio quality.

In response to determining that the received first media content exceeds the predetermined threshold of the one or more parameters, the vehicle-based media system may output the second media content from the second media source, thus “switching” from the first media content to the second media content.” These concepts and more are discussed in further detail below.

### II. Example Architecture

### A. Computing Device

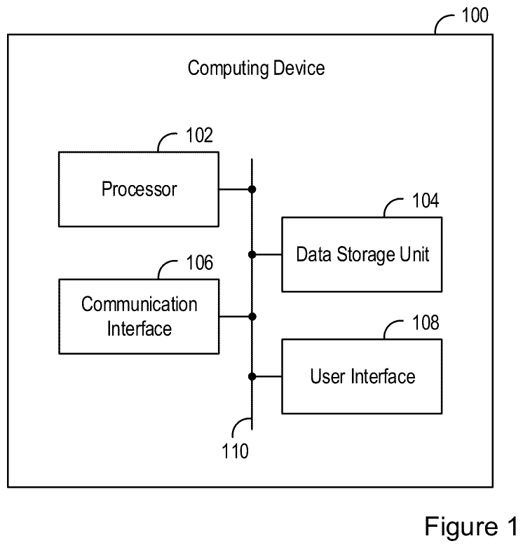

FIG. 1 is a simplified block diagram of an example computing device 100. Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (“DSP”)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (“HD-SDI”). In another example, communication interface 106 can be a wireless interface, such as a radio, cellular, or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission. Further, the term “connection mechanism” as used therein refers to one or more mechanisms that facilitate communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless)

User interface 108 can facilitate interaction between computing device 100 and a user of computing device 100, if applicable. As such, user interface 108 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, user interface 108 can include hardware and/or software components that facilitate interaction between computing device 100 and the user of the computing device 100.

In this disclosure, the term “computing system” means a system that includes at least one computing device, such as computing device 100. A computing system and/or components thereof can perform various acts, such as those set forth below.

In this disclosure, the term “vehicle-based media system” means a system that includes at least one computing device (e.g., computing device 100) that receives and presents media content to an occupant of a vehicle. The vehicle-based media system can receive the media content using a communication interface, such as communication interface 106, and can present the media content using a user interface, such as user interface 108.

### II. Example Operations

### A. Example Guis and Operational Environments

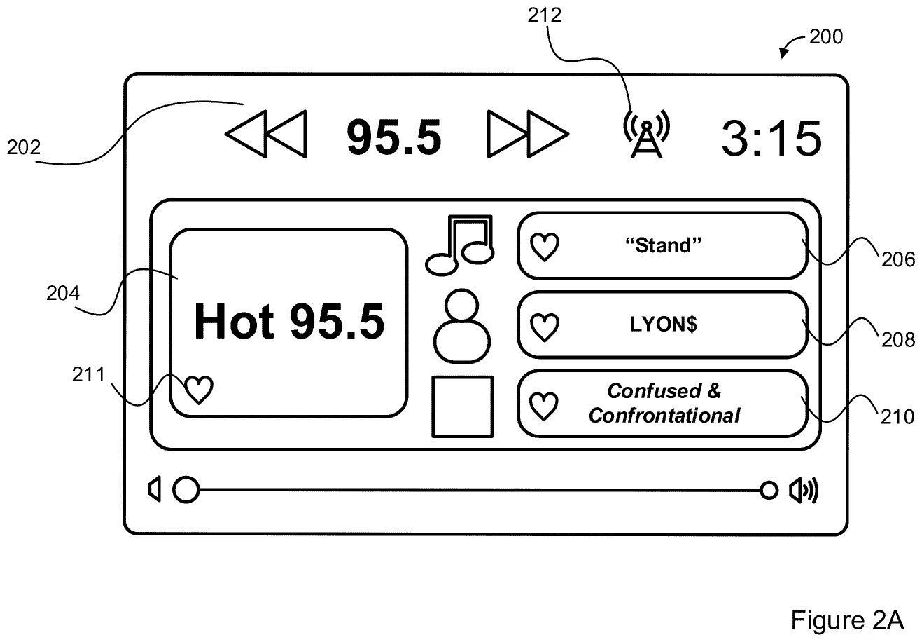

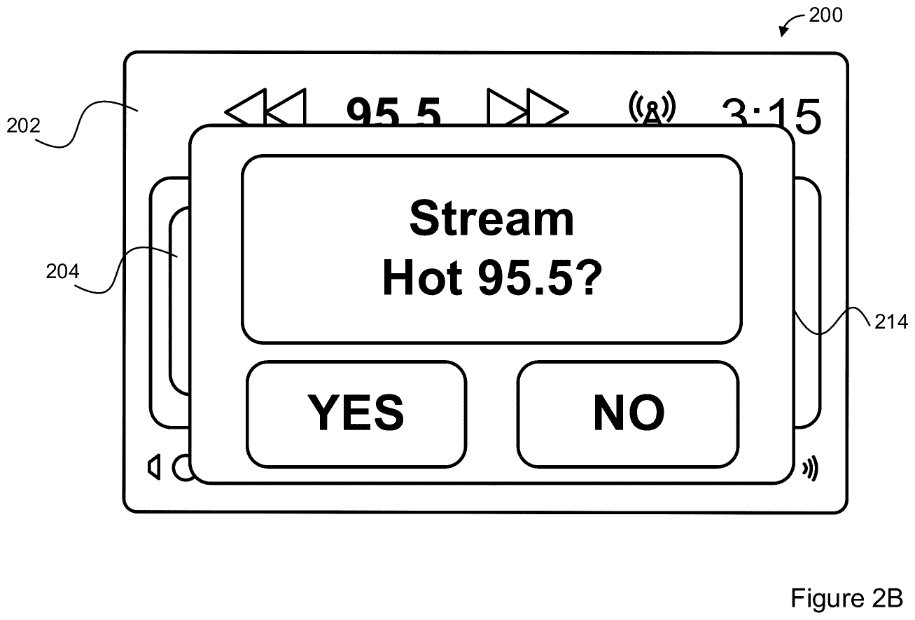

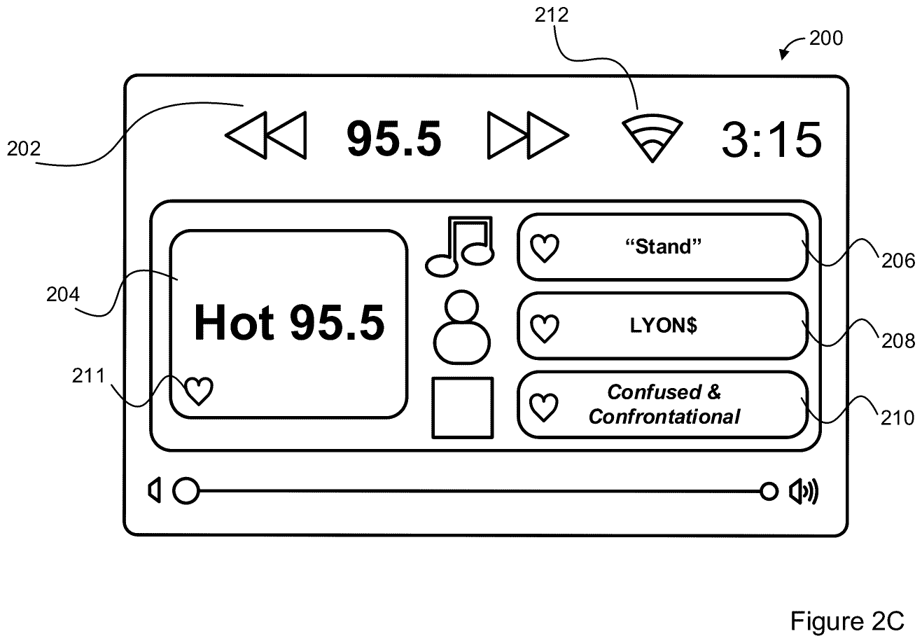

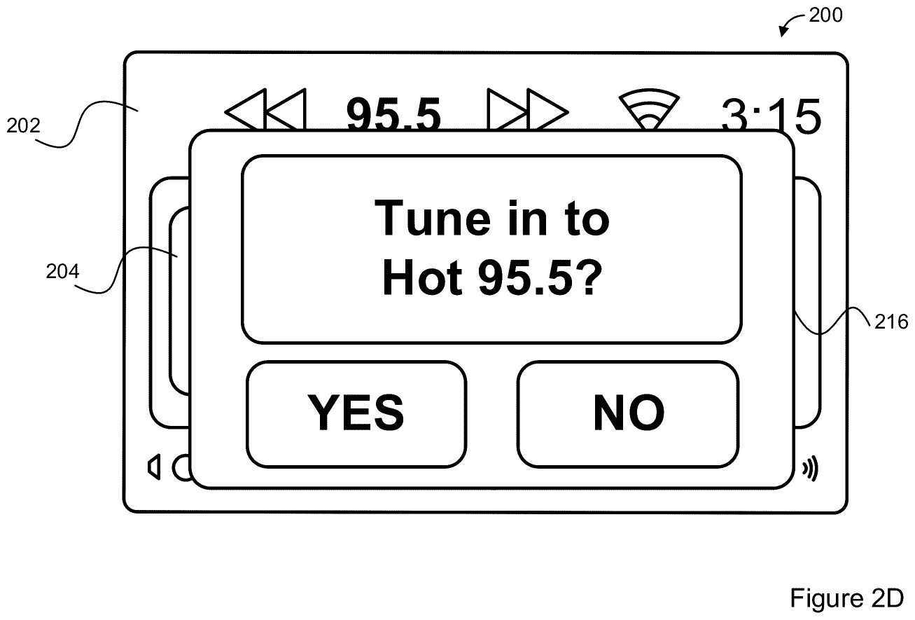

To further illustrate the above-described concepts and others, FIGS. 2A-2D depict example GUIs that a vehicle-based media system 200 can be configured to display in accordance with the techniques described above. The vehicle-based media system 200 can include one or more computing devices similar to or the same as the computing device 100 depicted in FIG. 1. Further, the example environments and GUIs depicted in FIGS. 2A-2D are only for illustrative purposes. The features described herein can involve environments, operations, GUIs, and functionalities that are configured or formatted differently, include additional or fewer components and/or more or less data, include different types of components and/or data, and relate to one another in different ways.

FIG. 2A depicts an example GUI of the vehicle-based media system 200 in a first state. Specifically, in this first state, the vehicle-based media system 200 displays a radio station 202 (“95.5”) in connection with an associated radio station logo 204 (“Hot 95.5”) and information indicating a song title 206 (“Stand”), artist title 208 (“LYON$”), and album title 210 (“Confused & Confrontational”), for musical media content received from the displayed radio station and currently playing on one or more speakers in the vehicle.

As also shown in FIG. 2A, the user may indicate that the radio station 202 is a “favorite” radio station via heart icon 211 on the radio station's logo 204, which may cause vehicle-based media system 200 to search and/or store information relating to radio station 202 (e.g., categories, formats, genres, content IDs) and take one or more responsive actions. In examples, based on a user indicating that radio station 202 is a favorite station, vehicle-based media system 200 may search for other radio stations that present the same or similar media content as radio station 202, which it may suggest to the user based on numerous factors (e.g., geographic location of the vehicle-based media system, if there is an interruption to the broadcast of radio station 202). Furthermore, the user of vehicle-based media system 200 may indicate one or more “favorite” features of the media content playing on vehicle-based media system, including the album (via album title 210), the artist (via artist title 208), and/or the song (via song title 206), among other possibilities. In examples, vehicle-based media system 200 may use these one or more “favorited” features of the media content playing on vehicle-based media system to find, store, and/or suggest to user, one or more similar albums, artists, and/or songs, among other possibilities.

Furthermore, in example embodiments, information related to media content, such as radio station 202, radio station logo 204, song title 206, artist title 208, and/or album title 210 as described above, may be encoded into media content received by the vehicle-based media system, and the vehicle-based media system can extract this information from the received media content. The vehicle-based media system 200 may also display a media source indicator 212 to indicate the source (e.g., a terrestrial radio broadcast or Internet-based media stream) of the content. In the example embodiment of FIG. 2A, media source indicator 212 includes an icon representing a radio tower, indicating that the vehicle-based media system 200 is tuned to a terrestrial radio station. The content being output by the vehicle-based media system 200 may be associated with a content ID, which is a unique identifier for that content. For example, a song, a radio show, episode of a podcast, and/or an audio account of a sports game or match may each have a unique content ID it is associated with.

FIG. 2B depicts the GUI of vehicle-based media system 200 depicted in FIG. 2A, but in a second state. In the second state, a pop-up window 214 has appeared on the GUI of the vehicle-based media system 200. This pop-up window 214 displays a prompt to the user, asking the user whether to stream (e.g., via one or more mobile computing devices associated with the vehicle-based media system using cellular data) the radio station 202. This prompt may be presented to the user in response to several different reasons, as discussed above. For example, if a vehicle is beginning to exit the range of a terrestrial broadcast, but the user (or other occupant of the vehicle) still wishes to listen to the same or similar content, the vehicle-based media system may switch to an Internet-based media stream of the same or similar content so that the user may continue listening even outside of the terrestrial broadcast range. In examples, this Internet-based media stream of the same or similar content may be streamed from one or more components of the vehicle-based media system 200 itself (e.g., from a cellular and/or WI-FI interface of the vehicle-based media system) and/or from one or more mobile devices connected to the vehicle-based media system, among other possibilities.

Before making this switch, the vehicle-based media system 200 may periodically identify or otherwise search for media content related to the content that is currently being output by the vehicle-based media system 200. This content may be associated with another media source that is the same or different than the media source currently being used by the vehicle-based media system. For example, a vehicle-based media system 200 tuned to a terrestrial radio station may search for currently-streaming Internet media streams. This may occur through the vehicle-based media system 200 searching through a database of content available on terrestrial broadcasts, digital radio broadcasts, satellite broadcasts, media streaming services, and/or Internet-based media streams. In some embodiments, the vehicle-based media system 200 may use an electronic program guide (EPG) to identify other media content.

Subsequently, the vehicle-based media system may determine whether the other media content it has identified is associated with the same content ID as described above, which may indicate that the content is the same (or similar). For example, a terrestrial broadcast of a baseball game and an Internet-based media stream of the same baseball game may have the same content ID.

After determining that another media content (e.g., a “second” media content) has the same content ID, the vehicle-based media system 200 may measure and/or determine one or more parameters related to the first content (in the example above, the terrestrial broadcast). The vehicle-based media system 200 may use these one or more parameters, or a subset thereof, to determine whether to switch (or prompt the user regarding a switch) the media sources. In some embodiments, this may involve determining whether the first content exceeds (or does not exceed) a predetermined threshold of one or more parameters. Examples are provided below.

In some embodiments, such parameters may include a signal-to-noise (SNR) ratio. For example, the vehicle-based media system 200 may compute an SNR at regular intervals for a terrestrial broadcast currently being received and played by the vehicle-based system 200, and if the SNR exceeds (or drops below) a predetermined threshold, the vehicle-based media system 200 may prompt the user to switch to a different media source (e.g., an Internet-based media stream, a satellite radio stream). In example embodiments, this SNR protocol may be carried out to ensure a high-quality listening experience for the user, as a low SNR may indicate poor audio quality. In some embodiments, the vehicle-based media system 200 may, while outputting a terrestrial, digital, and/or satellite radio broadcast, actively search for (e.g., periodically or at predefined intervals) other media sources for the same or similar content that may have a higher SNR. In such a situation, in example embodiments, the vehicle-based media system 200 may prompt the user to switch to this higher-SNR source, using a prompt similar to pop-up window 214 in FIG. 2B. A similar process may occur for other parameters, including other audio characteristic parameters such as loudness (or other volume-related parameter), gain, and/or timbre.

In some embodiments, the parameters may include contour data. Contour data is a predicted coverage area for a terrestrial broadcast, and may be calculated based on several characteristics of the broadcast tower, including height, power, and class. This parameter may be also be used to effect a switch. If a vehicle is exiting a contour area for a terrestrial broadcast, the vehicle-based media system 200 may prompt the user to switch to a different media source to continue playing the same content, as the broadcast may become weaker and thus the quality may degrade outside of the defined contour. In some embodiments, the parameters may also include signal strength (often measured in decibels (“dB”) or decibels per milliwatt (“dBm”)). Continuing the terrestrial broadcast example, the signal strength may be weaker in some areas (due to obstructions, distance, interference, or other anomalies), and thus the vehicle-based media system 200 may prompt the user to switch to a different media source based on one or more of the parameters discussed above.

In some embodiments, these one or more parameters may include a geographic location or geolocation data. Similar to the above, the vehicle-based media system 200 may determine a geographic location of the user and perform a switch based on the determined location. To determine the geographic location, the vehicle-based media system 200 may include a GPS transceiver, use the GPS transceiver of a coupled mobile device, or via another method. Based on this geographic location, if the vehicle-based media system 200 determines that the user is too far from a terrestrial broadcast tower, the vehicle-based media system 200 may prompt the user to switch to a different media source to continue playing the same content. Other examples are possible.

In FIG. 2C, the GUI of the vehicle-based media system 200 is shown in a third state, where the third state is similar to the second state depicted in FIG. 2B, except the pop-up window 214 has been closed and the vehicle-based media system 200 is now streaming the radio station 202 over mobile data, as indicated by the media source indicator 212 being a wireless signal icon.

In some embodiments, this transition between one media source and another may be configured to occur seamlessly (i.e., in such a way that is imperceptible to the user). In examples, this transition may be accomplished through the synchronization of both media sources and switching at a determined point (i.e. a pause or transition in the content).

Specifically, in order to reach the third state shown in FIG. 2C, at or around the time the vehicle-based media system 200 receives an affirmative response to the presented prompt in FIG. 2B, the vehicle-based media system 200 can perform the “switch,” by tuning out of the terrestrial broadcast and connecting to the Internet-based media stream. As described above, the vehicle-based media system 200 can present the prompt in response to several different actions occurring, but in some embodiments the switch may occur without a prompt or other user action. For example, a user (or an original equipment manufacturer of the vehicle-based media system 200) may be able to set a specific threshold of one or more parameters that, when determined to be exceeded, the vehicle-based media system 200 may automatically switch media sources.

FIG. 2D depicts the GUI of vehicle-based media system 200 depicted in FIG. 2C, but in a fourth state. In the fourth state, a pop-up window 216 has appeared on the GUI of the vehicle-based media system 200. This pop-up window 216 displays a prompt to the user, asking the user whether to tune in to (e.g., over a terrestrial broadcast) the radio station 202. This prompt may be presented to the user in response to several different scenarios, as discussed above.

The process leading to the prompt in FIG. 2D is similar to that described above, though pursuant to another process. For example, in example embodiments, if an Internet-based media stream's mobile data usage is beginning to approach a transmission limitation such as a mobile data limit, but the user desires to listen to the same content, the vehicle-based media system may switch to a terrestrial broadcast of the same content so that the user may continue listening. In examples, this Internet-based media stream of the same or similar content may be streamed from one or more components of the vehicle-based media system 200 itself (e.g., from a cellular and/or WI-FI interface of the vehicle-based media system) and/or from one or more mobile devices connected to the vehicle-based media system, among other possibilities.

Nevertheless, by doing so, in examples, the vehicle-based media system 200 delivers a higher-quality and/or more cost-effective version of the media content to one or more users of the vehicle-based media system 200.

Before making this switch, the vehicle-based media system 200 may periodically identify or otherwise search for media content related to the content that is currently being output by the vehicle-based media system 200. This content may be associated with another media source that is the same or different that the media source currently used by the vehicle-based media system. For example, a vehicle-based media system 200 using an Internet-based media stream may search for nearby terrestrial radio stations or available satellite radio station. This may occur through the vehicle-based media system 200 searching through a database of content available on terrestrial broadcasts, digital radio broadcasts, satellite broadcasts, or Internet-based media streams. In some embodiments, the vehicle-based media system 200 may use an EPG to identify other media content.

Subsequently, the vehicle-based media system may determine whether the other identified media content is associated with the same content ID (and/or categories, formats, genres, etc.) and the vehicle-based media system 200 may take one or more responsive actions based thereon. as described above. This would indicate that the content is the same (or similar). For example, a terrestrial broadcast of a baseball game and an Internet-based media stream of the same baseball game may have the same content ID. In some examples, the vehicle-based media system may search for information relating to radio station 202 (e.g., categories, formats, genres, content IDs) and/or information associated with the media content (e.g., an EPG that indicates whether the media content is live baseball game, news segment, etc.), and the vehicle-based media system 300 may take one or more responsive actions based thereon.

Further, in examples, the user may indicate that the baseball game and/or one of the teams in the baseball game is a “favorite” type of media content, which may cause vehicle-based media system 200 to search and/or store information relating to the baseball game and/or one of the teams in the baseball game, and take one or more responsive actions. In examples, based on a user indicating that the baseball game and/or one of the teams in the baseball game includes a “favorite” content, vehicle-based media system 200 may search for other radio stations that present the same or similar media content, which it may suggest to the user based on numerous factors (e.g., geographic location of the vehicle-based media system, if there is an interruption to the broadcast of the game) and/or find, store, and/or suggest to user, one or more similar types of content (based on, e.g., categories, formats, genres, content IDs), among other possibilities.

After determining that the other (or “second”) media content has the same content ID, the vehicle-based media system 200 may measure and/or determine one or more parameters related to the first content (in this current example, the Internet-based media stream). The vehicle-based media system 200 may use these one or more parameters, or a subset thereof, to determine whether to switch (or prompt the user regarding a switch) the media sources. In some embodiments, this may involve determining whether the first content exceeds (or drops below) a predetermined threshold of one or more parameters. Examples are provided below.

In some embodiments, such parameters may include a bitrate, or the amount of data in the media stream in a specific period of time. A higher bitrate is generally associated with higher media quality. For example, the vehicle-based media system 200 may compute a bitrate at regular intervals for an Internet-based media stream being received and played by the vehicle-based media system 200. As a higher bitrate necessarily means higher data usage, if a bitrate exceeds a certain threshold, the vehicle-based media system 200 may switch to a different media source. This may also occur in the case where the bitrate is too low for the media to be intelligible. Such thresholds may be set by the user and/or by the original equipment manufacturer of the vehicle-based media system 200.

As noted above, different bitrates generally indicate different data usage statistics with regards to Internet-based media streams. Thus, in some embodiments, the vehicle-based media system 200 may compute a total data usage for an Internet-based media stream. As some mobile devices or vehicle-based media systems are subject to one or more mobile data transmission limitations (e.g., poor service, data limits), the vehicle-based media system 200 may switch (or prompts the user to switch) to a different media source should it determine that the stream has caused a mobile data limit to be exceeded, or alternatively, where the user sets a lower threshold so that the system switches (or prompts the user to switch) when approaching the mobile data limit.

In some embodiments, the parameters may also include signal strength, often measured in decibels per milliwatt (dBm). For example, if a signal strength is particularly high in a certain area, the vehicle-based media system 200 may switch (or prompts the user to switch) to a terrestrial broadcast.

In some embodiments, the parameters may include a geographic location. Similar to the above, the vehicle-based media system 200 may determine a geographic location of the user and perform a switch based on the determined location. To determine the geographic location, the vehicle-based media system 200 may include a GPS transceiver, use the GPS transceiver of a coupled mobile device, or determine the geographic location via another method. Based on this geographic location, if the vehicle-based media system 200 determines that the user is close to a terrestrial broadcast tower, the vehicle-based media system 200 may prompt the user to switch to a terrestrial broadcast to continue playing the same content.

In some embodiments, as noted above, this transition between one media source and another may be configured to occur seamlessly (i.e., in such a way that is imperceptible to the user). This may be accomplished through the synchronization of both media sources and switching at a determined point (i.e. a pause or transition in the content).

After the switch described above has occurred, the vehicle-based media system may return to a state similar to that of FIG. 2A.

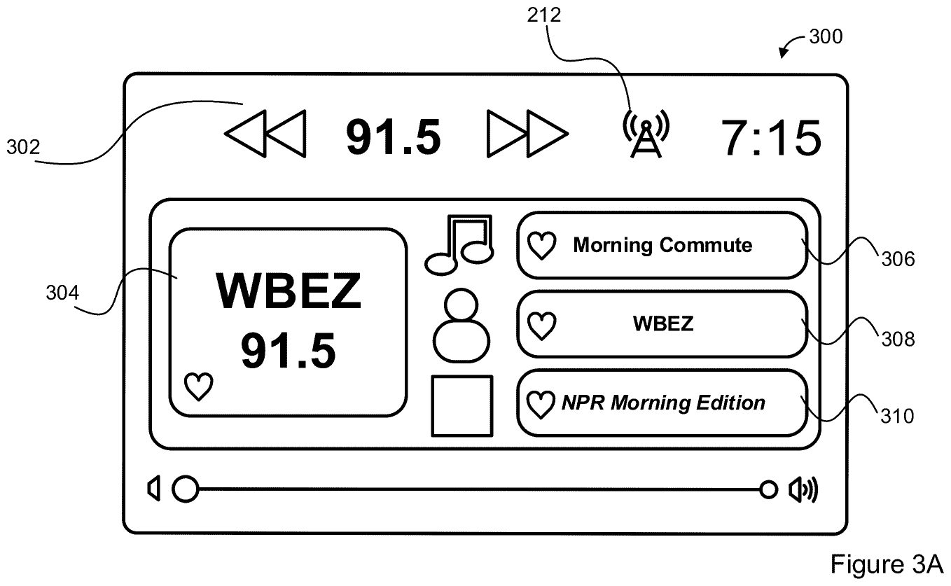

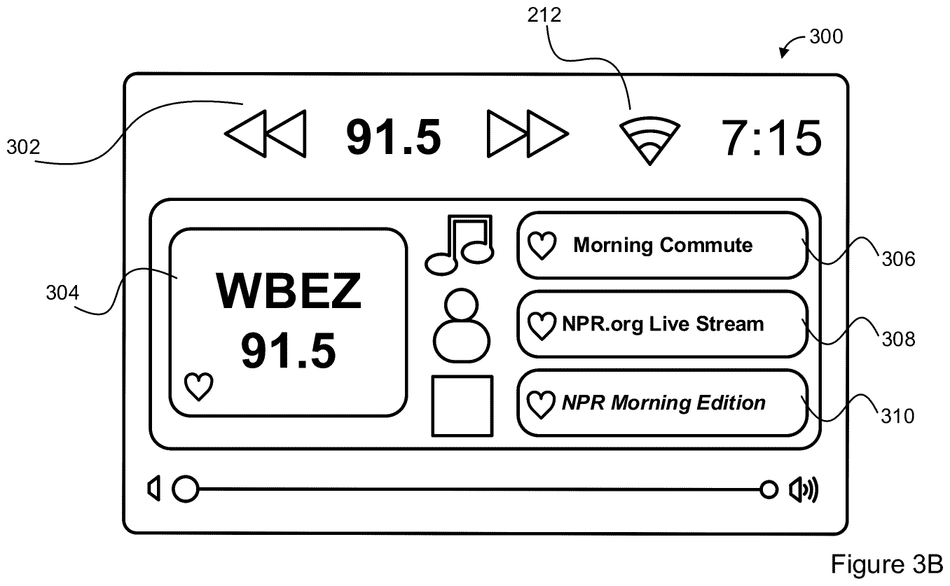

FIG. 3A depicts an example GUI of a vehicle-based media system 300 in a first state. The vehicle-based media system 300 may be the same as the vehicle-based media system 200 depicted in FIGS. 2A-2D. Specifically, in this first state, the vehicle-based media system 300 displays a radio station 302 (“91.5”) in connection with an associated radio station logo 304 (“WBEZ 91.5”) and information indicating a playlist 306 (“Morning Commute”), station title 308 (“WBEZ”), and radio show title 310 (“NPR Morning Edition”). The vehicle-based media system 300 may also display a media source indicator 312 to indicate the media source (e.g., a terrestrial radio broadcast or Internet-based media stream) of the content. In FIG. 3A, the media source indicator 312 is an icon representing a radio tower, indicating that the vehicle-based media system 300 is tuned to a terrestrial radio station.

The example GUI of FIG. 3A reflects an embodiment where a user may set default behavior regarding content switching. For instance, when driving to work in the morning, a user may prefer to listen to a specified playlist (e.g., playlist 306), that includes a specific local radio station (e.g., radio station 302). In this example, the radio station is 91.5 WBEZ, Chicago's National Public Radio (“NPR”) affiliate. The user may set default behavior (e.g., one or more alternative options) in case one or more items of the playlist drops below or exceeds a specified parameter or is unavailable for a certain reason. Additionally, one or more predetermined operations may be set in connection with “favorited” content or features, as described above with relation to FIG. 2A.

FIG. 3B illustrates this example process. As shown in FIG. 3B, while WBEZ is still displayed, the station title 308 has switched to “NPR. org Live Stream,” and the media source indicator 312 has switched to a wireless symbol, indicating that the vehicle-based media system has switched to an Internet-based media stream.

This default behavior may also be extended to other options. For example, a user embarking on a road trip from Chicago, Illinois to Omaha, Nebraska may begin their trip listening to WBEZ and wish to continue listening to NPR throughout their whole trip. Thus, in examples, when the user begins to exit the contour of WBEZ, the vehicle-based media system 300 may be configured to switch to an Internet-based media stream of NPR, for example from its website NPR. org. In some examples, when the user begins to exit the contour of WBEZ, the vehicle-based media system 300 may be configured to switch and/or otherwise launch an Internet-based media stream of NPR within one or more mobile applications (e.g., an NPR mobile application). In some example embodiments, the vehicle-based media system 300 may be configured to actively search for other NPR stations playing the same content as the Internet-based media stream, and if a such a station is found, switch automatically (or prompt the user to switch) based on that configuration.

In examples, this functionality may be accomplished through a playlist creation feature on the GUI of the vehicle-based media system 300, which would allow the user to set switching behavior and select what type of content they would like to hear on their commute. These example operations allows the user to listen to the preferred content (e.g., radio stations) along their route carry the content they wish to hear, thus improving their experience. Other examples are possible.

In some examples, one or more functions described in connection with FIGS. 3A-3B may also include the vehicle-based media system searching for and/or storing information relating to radio station 302 (e.g., categories, formats, genres, content IDs) and/or information associated with the media content that indicates one or more characteristics of the media content (e.g., an EPG that indicates whether the media content is live baseball game, news segment, etc.), and the vehicle-based media system 300 may take one or more responsive actions based thereon, including those described in connection with FIGS. 2A-2D above.

### B. Example Methods and Aspects

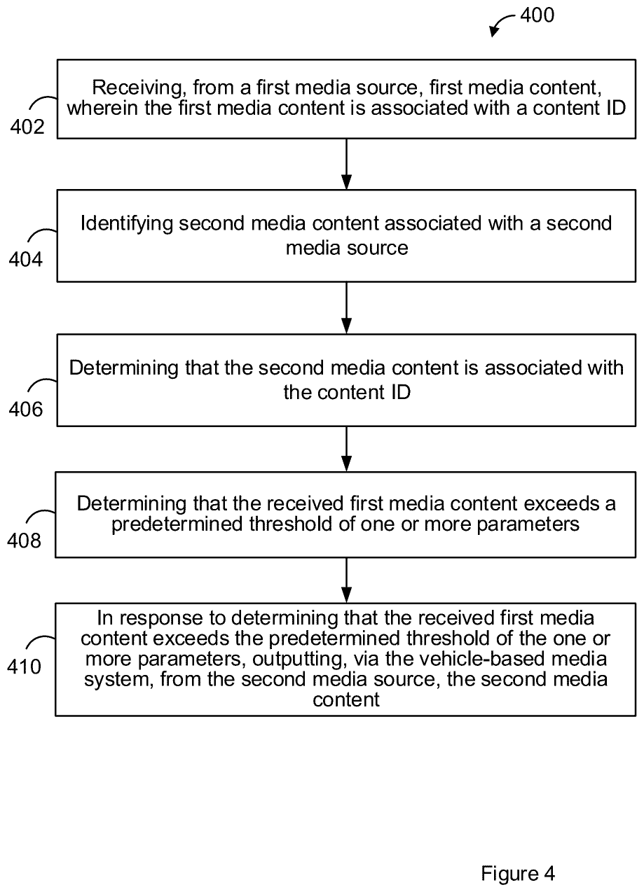

FIG. 4 is a flow chart illustrating an example method 400. The method 400 may be a computer-implemented method, and/or may be carried out by a vehicle-based media system, and/or may be carried out in response to instructions stored on a non-transitory computer-readable medium being executed by a vehicle-based media system.

At block 402, the method 400 may involve receiving, from a first media source, first media content, wherein the first media content is associated with a content ID. In some embodiments, the first media source includes a terrestrial broadcast. In some embodiments, the first media source includes an Internet-based media stream. In some embodiments, the terrestrial broadcast includes a radio broadcast.

At block 404, the method 400 may involve identifying second media content associated with a second media source. In some embodiments, the second media source includes an Internet-based media stream. In some embodiments, the second media source includes a terrestrial broadcast.

At block 406, the method 400 may involve determining that the second media content is associated with the content ID. In some embodiments, determining that the first and second media content are associated with the content ID involves determining that the first media content exceeds a threshold extent of similarity with the second media content.

At block 408, the method 400 may involve determining that the received first media content exceeds a predetermined threshold of one or more parameters. In some embodiments, the one or more parameters include at least one of a signal-to-noise ratio, contour data, signal strength, and/or a geographic location. In some embodiments, the one or more parameters include at least one of a bitrate, data usage, and/or signal strength.

At block 410, the method 400 may involve, in response to determining that the received first media content exceeds the predetermined threshold of the one or more parameters, outputting, via the vehicle-based media system, from the second media source, the second media content.

In some embodiments, the method 400 may involve, prior to outputting the second media content, receiving, from a mobile device associated with the vehicle-based media system, the second media content.

In some embodiments, the first and second media content each include audio content. In some embodiments, the first and second media content each include video content.

In line with the disclosure herein, in one aspect, a vehicle-based media system may include (a) one or more processors, and (b) a non-transitory machine-readable medium, having stored thereon program instructions that, upon execution by the one or more processors, cause the vehicle-based media system to perform a set of operations comprising: (a) receiving, from a first media source, first media content, wherein the first media content is associated with a content ID; (b) identifying second media content associated with a second media source; (c) determining that the second media content is associated with the content ID; (d) determining that the received first media content exceeds a predetermined threshold of one or more parameters; (e) in response to determining that the received first media content exceeds the predetermined threshold of the one or more parameters, outputting, via the vehicle-based media system, from the second media source, the second media content.

In another aspect, in some embodiments, the first media source includes a terrestrial broadcast, and the second media source comprises an Internet-based media stream.

In another aspect, in some embodiments, the one or more parameters include at least one of a signal-to-noise ratio, contour data, signal strength, and/or a geographic location.

In another aspect, in some embodiments, the terrestrial broadcast includes a radio broadcast.

In another aspect, in some embodiments, the first media source includes an Internet-based media stream, and the second media source comprises a terrestrial broadcast.

In another aspect, in some embodiments, the one or more parameters include at least one of a bitrate, data usage, and/or signal strength.

In another aspect, in some embodiments, determining that the first and second media content are associated with the content ID includes determining that the first media content exceeds a threshold extent of similarity with the second media content. In some embodiments, this may involve (i) generating audio fingerprint data for each of the first and second media content, (ii) comparing the generated audio fingerprint data, and (iii) determining that the fingerprint data for the first media content has at least the threshold extent of similarity with the fingerprint data for the second media content.

In another aspect, in some embodiments, the operations further include, prior to outputting the second media content, receiving, from a mobile device associated with the vehicle-based media system, the second media content.

In another aspect, in some embodiments, the first and second media content each include audio content.

In another aspect, in some embodiments, the first and second media content each include video content.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects.

1. A vehicle-based media system comprising:
one or more processors; and
a non-transitory machine-readable medium, having stored thereon program instructions that, upon execution by the one or more processors, cause the vehicle-based media system to perform a set of operations comprising:
receiving, from a first media source, first media content, wherein the first media content is associated with a content ID;
identifying second media content associated with a second media source;
determining that the second media content is associated with the content ID;
determining that the received first media content exceeds a predetermined threshold of one or more parameters; and
in response to determining that the received first media content exceeds the predetermined threshold of the one or more parameters, outputting, via the vehicle-based media system, from the second media source, the second media content.

2. The vehicle-based media system of claim 1, wherein the first media source comprises a terrestrial broadcast, and wherein the second media source comprises an Internet-based media stream.

3. The vehicle-based media system of claim 2, wherein the one or more parameters comprises at least one of: (i) a signal-to-noise ratio; (ii) contour data; (iii) signal strength; or (iv) a geographic location.

4. The vehicle-based media system of claim 2, wherein the terrestrial broadcast comprises a radio broadcast.

5. The vehicle-based media system of claim 1, wherein the first media source comprises an Internet-based media stream, and wherein the second media source comprises a terrestrial broadcast.

6. The vehicle-based media system of claim 5, wherein the one or more parameters comprises at least one of: (i) a bitrate; (ii) data usage; or (iii) signal strength.

7. The vehicle-based media system of claim 1, wherein determining that the first and second media content are associated with the content ID comprises determining that the first media content exceeds a threshold extent of similarity with the second media content.

8. The vehicle-based media system of claim 1, wherein the operations further comprise, prior to outputting the second media content, receiving, from a mobile device associated with the vehicle-based media system, the second media content.

9. The vehicle-based media system of claim 1, wherein the first and second media content each comprise audio content.

10. The vehicle-based media system of claim 1, wherein the first and second media content each comprise video content.

11. A non-transitory machine-readable medium, having stored thereon program instructions that, upon execution by a vehicle-based media system, cause the vehicle-based media system to perform a set of operations comprising:
receiving, from a first media source, first media content, wherein the first media content is associated with a content ID;
identifying second media content associated with a second media source;
determining that the second media content is associated with the content ID;
determining that the received first media content exceeds a predetermined threshold of one or more parameters; and
in response to determining that the received first media content exceeds the predetermined threshold of the one or more parameters, outputting, via the vehicle-based media system, from the second media source, the second media content.

12. The non-transitory machine-readable medium of claim 11, wherein the first media source comprises a terrestrial broadcast, and wherein the second media source comprises an internet-based media stream.

13. The non-transitory machine-readable medium of claim 12, wherein the one or more parameters comprises at least one of: (i) a signal-to-noise ratio; (ii) contour data; (iii) signal strength; or (iv) a geographic location.

14. The non-transitory machine-readable medium of claim 12, wherein the terrestrial broadcast comprises a radio broadcast.

15. The non-transitory machine-readable medium of claim 11, wherein the first media source comprises an internet-based media stream, and wherein the second media source comprises a terrestrial broadcast.

16. The non-transitory machine-readable medium of claim 15, wherein the one or more parameters comprises at least one of: (i) a bitrate; (ii) data usage; or (iii) signal strength.

17. The non-transitory machine-readable medium of claim 11, wherein determining that the first and second media content are associated with the content ID comprises determining that the first media content exceeds a threshold extent of similarity with the second media content.

18. The non-transitory machine-readable medium of claim 11, wherein the operations further comprise, prior to outputting the second media content, receiving, from a mobile device associated with the vehicle-based media system, the second media content.

19. The non-transitory machine-readable medium of claim 11, wherein the first and second media content each comprise at least one of: (i) audio content; or (ii) video content.

20. A computer-implemented method comprising:
receiving, from a first media source, first media content, wherein the first media content is associated with a content ID;
identifying second media content associated with a second media source;
determining that the second media content is associated with the content ID;
determining that the received first media content exceeds a predetermined threshold of one or more parameters; and
in response to determining that the received first media content exceeds the predetermined threshold of the one or more parameters, outputting, via a vehicle-based media system, from the second media source, the second media content.
